(19) United States
(12) Patent Application Publication
(10) Pub. No.: US 2011/0161008 A1
(43) Pub. Date: Jun. 30, 2011

(54) LAND SETTLEMENT MEASURING APPARATUS AND SYSTEM

(76) Inventor: Keun-Ho Lee, Gwangju (KR)

(21) Appl. No.: 13/057,112

(22) PCT Filed: Jul. 16, 2009
(86) PCT No.: PCT/KR09/03924

§ 371 Date: Feb. 1, 2011

(30) Foreign Application Priority Data
Aug. 5, 2008 (KR) 10-2008-0076406

(51) Int. Cl. G06F 19/00

(52) U.S. Cl. 702/2

(57) ABSTRACT

Provided are a land settlement measuring apparatus and a land settlement measuring system. The land settlement measuring apparatus includes a magnetic field detection unit, a microprocessor, and a containing unit. The magnetic field detection unit includes a plurality of magnetic field detection sensors that are separated from each other in a predetermined interval. The microprocessor calculates a differential settlement amount based on a magnetic field detection signal transmitted from the magnetic field detection unit, in the case where a change in the magnetic field is detected by the sensor. The containing unit contains the magnetic field detection unit and the microprocessor. The land settlement measuring system includes a magnetic field generation unit, a land settlement measuring apparatus, and a data logger. The magnetic field generation unit is disposed at a predetermined position of a ground to be adjacent to a hole which is perforated down to an unmovable layer. The land settlement measuring apparatus passes through the hole so that the one end thereof is fixed to the unmovable layer, the land settlement measuring apparatus measuring a differential settlement amount according to a change in the position of the magnetic field generation unit. The data logger stores a result of the measurement transmitted from the land settlement measuring apparatus. According to the configuration, it is possible to collectively measure a differential settlement amount of a surface of a settling layer and a differential settlement amount of the settling layer in one system and to obtain a more accurate value of the measurement.

### TECHNICAL FIELD

The present invention relates to a land settlement measuring apparatus and system, and more particularly, to a land settlement measuring apparatus and system capable of collectively measuring a differential settlement amount of a surface of a settling layer and a differential settlement amount of the settling layer at the time of filling work.

### BACKGROUND ART

When filling work is performed in various civil engineering works, consolidation of ground inevitably occurs due to a weight of the filling layer. With respect to a portion (hereinafter, referred to as a settling layer) from the bottom of the filling layer to the top of an unmovable layer (sometimes referred to as a supporting layer where is assumed not to be leveled down), settlement occurs in the central portion of the settling layer as well as the surface of the settling layer.

Since the settlement occurs non-uniformly over the entire settling layer, a change in the differential settlement amount of the surface of the settling layer and a change in the differential settlement amount need to be accurately measured for a mechanical analysis of the ground.

FIG. 1 is a longitudinal cross-sectional view illustrating a structure of a conventional differential settlement gauge. Now, a method of construction of the differential settlement gauge and a measuring method thereof are described.

A hole 40 is perforated to pass through the settling layer 20 down to the unmovable layer 10. Next, a non-magnetic guide pipe 42 is inserted into the hole 40 down to the bottom thereof. A reference point magnet 100 is disposed at a position of the unmovable layer 10 corresponding to the low end portion of the guide pipe 42.

Next, a spider magnet 200 is lifted down along the hole 40 so that an inner surface of a deep through-hole of the spider magnet 200 is in contact with an outer surface of the guide pipe 42. The spider magnet 200 is allowed to stop at a position where the differential settlement amount is to be measured. A grouting 48 is performed in the remaining space of the hole 40 by using packing means.

After a predetermined time elapses, a probe 44 is inserted into the inner portion of the guide pipe 42 and lifted down. When the probe 44 reaches the position of the spider magnet 200, an indicator 46 issues a predetermined signal. A relative position difference with respect to the reference point magnet 100 is measured, so that the differential settlement amount of the settling layer 20, where the spider magnet 200 is located, can be calculated.

However, the conventional differential settlement gauge has the following problems.

Firstly, the ground settlement continuously proceeds for a long time. In the conventional method of measuring the differential settlement amount, since the probe 44 needs to be inserted through the guide pipe 42 every time of measurement, there is a problem in the measurement work is complicated.

Secondly, since only the differential settlement amount is measured irrespective of the measurement of the differential settlement amount of the surface of the settling layer 20, there is a problem in that a separate settlement plate needs to be disposed on the surface of the settling layer 20 so as to measure the differential settlement amount of the surface.

### DISCLOSURE

### Technical Problem

The present invention provides capable of collectively measuring a differential settlement amount of a surface of a settling layer and a differential settlement amount of the settling layer at the time of filling work.

### Technical Solution

According to an aspect of the present invention, there is provided a land settlement measuring apparatus including a magnetic field detection unit, a microprocessor, a containing unit.

In the above aspect, the magnetic field detection unit may include a plurality of magnetic field detection sensors that are separated from each other in a predetermined interval. The microprocessor may calculate a differential settlement amount based on a magnetic field detection signal transmitted from the magnetic field detection unit, in the case where a change in the magnetic field is detected by the sensor. The containing unit may contain the magnetic field detection unit and the microprocessor.

In addition, the land settlement measuring apparatus may further include an interval maintaining rod that supports the containing unit at a predetermined interval.

According to another aspect of the present invention, there is provided a land settlement measuring system including a magnetic field generation unit, a land settlement measuring apparatus, and a data logger.

In the above aspect, the magnetic field generation unit may be disposed at a predetermined position of a ground to be adjacent to a hole which is perforated down to an unmovable layer

In addition, the land settlement measuring apparatus may pass through the hole so that the one end thereof is fixed to the unmovable layer, the land settlement measuring apparatus measuring a differential settlement amount according to a change in the position of the magnetic field generation unit. The data logger may store a result of the measurement transmitted from the land settlement measuring apparatus.

In addition, the magnetic field generation unit may include a reference point magnet which is fixed to the unmovable layer and used as a reference point at the time of measurement of the differential settlement amount.

In addition, the magnetic field generation unit may further include a spider magnet which is disposed at a predetermined position of the settling layer to measure the differential settlement amount.

In addition, the magnetic field generation unit may further include a plate magnet which is disposed at a predetermined position of the surface of the settling layer and at a predetermined position of the filling layer to measure the differential settlement amount. The land settlement measuring apparatus may include a magnetic field detection unit, a microprocessor, and a containing unit.

The magnetic field detection unit may include a plurality of magnetic field detection sensors that are separated from each other in a predetermined interval. The microprocessor may calculate a differential settlement amount based on a magnetic field detection signal transmitted from the magnetic field detection unit, in the case where a change in the magnetic field is detected by the sensor. The containing unit may contain the magnetic field detection unit and the microprocessor.

In addition, the land settlement measuring apparatus may further include an interval maintaining rod that supports the containing unit at a predetermined interval.

### Advantageous Effects

According to the present invention, it is possible to provide a land settlement measuring apparatus and system capable of collectively measuring a differential settlement amount of a surface of a settling layer and a differential settlement amount of the settling layer in one system and capable of obtaining a more accurate value of the measurement.

### DESCRIPTION OF DRAWINGS

FIG. 1 is a longitudinal cross-sectional view illustrating a structure of a conventional differential settlement gauge.

FIG. 2 is a view illustrating a land settlement measuring system according to an embodiment of the present invention.

FIG. 3 is a view illustrating a land settlement measuring apparatus according to an embodiment of the present invention.

FIG. 4 is a longitudinal cross-sectional view illustrating a plate magnet of a magnetic field generation unit.

FIG. 5 is a longitudinal cross-sectional view illustrating a spider magnet of a magnetic field generation unit.

FIG. 6 is a view illustrating a differential settlement amount measuring method according to an embodiment of the present invention.

### BEST MODE

Hereinafter, exemplary embodiments of the present invention will be described with reference to the accompanying drawings. For the better understanding of the invention, in the drawings, the same elements are denoted by the same reference numerals.

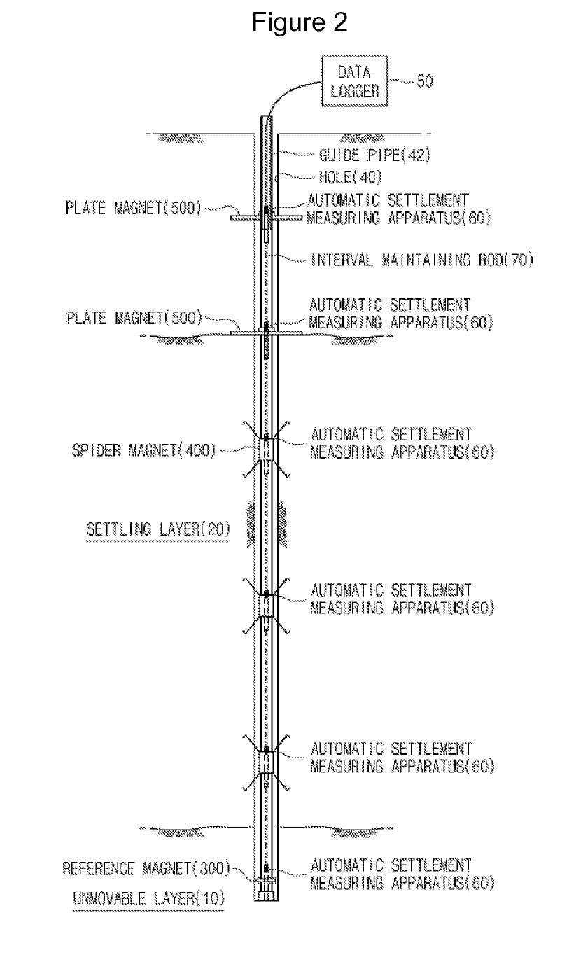

FIG. 2 is a view illustrating a land settlement measuring system according to an embodiment of the present invention.

The land settlement measuring system according to the present invention includes a magnetic field generation units 300, 400, and 500, a land settlement measuring apparatus 60, and a data logger 50.

The magnetic field generation units 300, 400, and 500 are disposed at predetermined positions of the ground to be adjacent to a hole 10, which is perforated down to an unmovable layer 10, and are configured to generate magnetic fields.

In other words, the hole 40 is vertically perforated through a settling layer 20 down to the unmovable layer 10. The magnetic field generation units 300, 400, and 500 are fixed to a position the settling layer 30 where a differential settlement amount is to be measured and a position of a filling layer which is generated by a filling work. At this time, a guide pipe 42 may be perforated through an inner portion of the hole 10.

Each of the magnetic field generation units 300, 400, and 500 includes a material for generating the magnetic field such as a magnet therein. In order to accurately detect the generated magnetic fields, the magnetic field generation units 300, 400, and 500 are disposed to be adjacent to the hole 40.

In addition, the magnetic field generation units 300, 400, and 500 may include a reference point magnet 300 which is used as a reference point at the time of measurement of the differential settlement amount. The magnetic field generation units 300, 400, and 500 may be fixed so as to be adjacent to the hole 40 in unmovable layer 10. Alternatively, the magnetic field generation units 300, 400, and 500 may be fixed to the position of the unmovable layer 10 and to be in contact with an outer surface of the guide pipe 42.

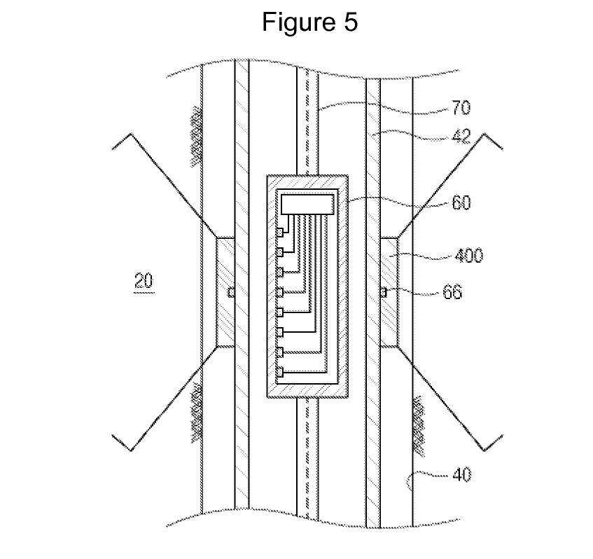

In addition, the magnetic field generation units 300, 400, and 500 may include a spider magnet 400 which is disposed at a predetermined position of the settling layer 20 to measure the differential settlement amount. Referring to FIG. 5, the spider magnet 400 may be fixed to the predetermined position of the settling layer 20 by using a plurality of legs. Alternatively, the spider magnet 400 may have any shape to be fixed to the ground.

In addition, the magnetic field generation units 300, 400, and 500 may further include a plate magnet 500 which is disposed at a predetermined position of the surface of the settling layer 20 and at a predetermined position of the filling layer to measure the differential settlement amount.

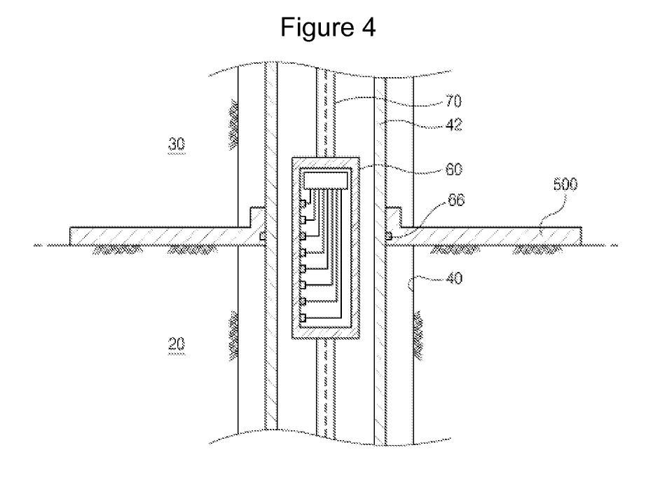

Referring to FIG. 4, the plate magnet 500 has a shape of a plate so as to be easily put on the ground. The plate magnet 500 can measure the differential settlement amount of the surface of the filling layer formed by the filling work as well as the differential settlement amount of the surface of the settling layer 20. In this case, after the filling work is performed up to the desired position, the plate magnet 500 is disposed at the position, and the filling work is performed thereon again. Therefore, the deposition of the plate magnet 500 is completed.

In addition, the land settlement measuring apparatus 60 passes through the hole 40 so that the one end side thereof is fixed to the unmovable layer 10. Next, the differential settlement amount is measured according to a change in the positions of the magnetic field generation units 300, 400, and 500.

In the case where the settling layer 20 is leveled down, since the magnetic field generation units 300, 400, and 500 are also moved down due to the settlement of the ground, the positions of the magnetic field generation units 300, 400, and 500 are changed. However, since the land settlement measuring apparatus 60 is fixed to the unmovable layer 10, the differential settlement amount can be calculated from the measured value of the changed positions of the magnetic field generation units 300, 400, and 500.

In addition, the data logger 50 stores a result of the measurement transmitted from the land settlement measuring apparatus 60.

According to the above configuration, the surface differential settlement amount and the differential settlement amount can be collectively measured in one system.

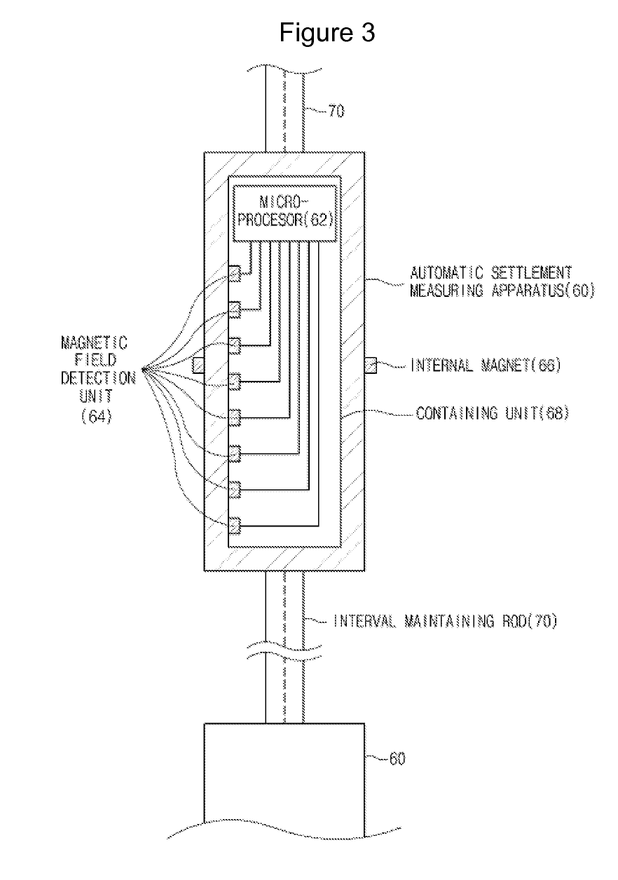

FIG. 3 is a view illustrating a land settlement measuring apparatus 60 according to an embodiment of the present invention.

In order to achieve the aforementioned object, the land settlement measuring apparatus 60 according to the present invention includes a magnetic field detection unit 64, a microprocessor 62, and a containing unit 68.

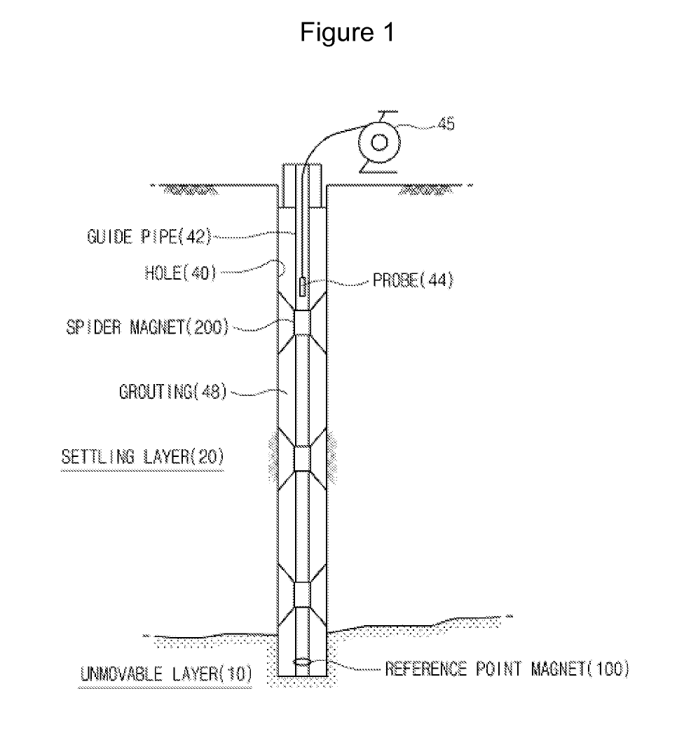

The magnetic field detection unit 64 includes a plurality of magnetic field detection sensors that are separated from each other in a predetermined interval. Due to the configuration, since an externally-generated magnetic field and an infinitesimal magnetic field can be detected, accurate values of measurement can be obtained in comparison with the conventional differential settlement gauge shown in FIG. 1.

In the case where a change in the magnetic field is detected by the sensor, the microprocessor 62 calculates the differential settlement amount based on a magnetic field detection signal transmitted from the magnetic field detection unit 64. The microprocessor 62 may be connected to a plurality of the magnetic field detection units 64 and an interval maintaining rod 70 described later.

The containing unit 68 contains the magnetic field detection unit 64 and the microprocessor 62. The containing unit 68 may further contain a communication unit (not shown) that transmits the differential settlement amount calculated by the microprocessor 62 to the data logger 50 in a wireless or wired commutation manner.

In the case of using the wired communication, the communication unit (not shown) may be connected to a communication rod which is located in the inner portion of the interval maintaining rod 70.

In addition, the interval maintaining rod 70 that supports the containing unit 69 at the predetermined interval may be further provided. In addition, the interval maintaining rod 70 may be include the aforementioned communication rod. In addition, due to the interval maintaining rod 70, a plurality of the containing units 68 may be aligned and fixed to the positions of the magnetic field generation units 300, 400, and 500.

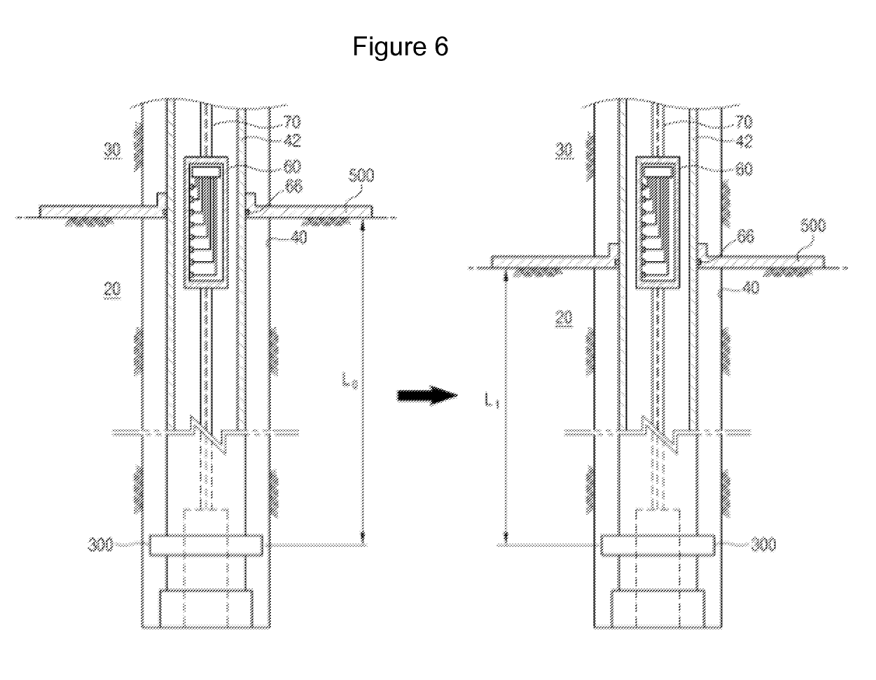

FIG. 6 is a view illustrating a differential settlement amount measuring method according to an embodiment of the present invention.

In this method, the plate magnet 500 is disposed on the surface of the settling layer 20; and in the case where settlement of the settling layer 20 occurs, the differential settlement amount of the surface of the settling layer 20 is calculated from the measured magnetic field signal.

In the figure, the left view illustrates the state before the occurrence of the settlement, and the right view illustrates the state after the occurrence of the settlement.

Before the occurrence of the settlement, the plate magnet 500 is located at the position of the second magnetic field detection unit 64 (with reference to the top of the land settlement measuring apparatus). Therefore, the second magnetic field detection unit 64 detects the magnetic field generated from the plate magnet 500.

After the occurrence of the settlement, the plate magnet 500 is located at the position of the fourth magnetic field detection unit 64 (with reference to the top of the land settlement measuring apparatus). Therefore, the fourth magnetic field detection unit 64 detects the magnetic field generated from the plate magnet 500.

If the height of the plate magnet 500 from the reference point magnet 300 before the occurrence of the settlement is denoted by ‘L0’, and The height of the plate magnet 500 from the reference point magnet 300 after the occurrence of the settlement is denoted by ‘L1’, the differential settlement amount of the surface of the settling layer 20 can be obtained as ‘L0−L1’.

While the present invention has been particularly shown and described with reference to exemplary embodiments thereof, it will be understood by those skilled in the art that various changes in form and details may be made therein without departing from the spirit and scope of the present invention as defined by the appended claims.

1. A land settlement measuring apparatus comprising:
a magnetic field detection unit that includes a plurality of magnetic field detection sensors that are separated from each other in a predetermined interval;
a microprocessor that calculates a differential settlement amount based on a magnetic field detection signal transmitted from the magnetic field detection unit, in the case where a change in the magnetic field is detected by the sensor; and
a containing unit that contains the magnetic field detection unit and the microprocessor.

2. The land settlement measuring apparatus according to claim 1, further comprising an interval maintaining rod that supports the containing unit at a predetermined interval.

3. A land settlement measuring system comprising:
a magnetic field generation unit which is disposed at a predetermined position of a ground to be adjacent to a hole which is perforated down to an unmovable layer;
a land settlement measuring apparatus which passes through the hole so that the one end thereof is fixed to the unmovable layer, the land settlement measuring apparatus measuring a differential settlement amount according to a change in the position of the magnetic field generation unit; and
a data logger which stores a result of the measurement transmitted from the land settlement measuring apparatus.

4. The land settlement measuring system according to claim 3, wherein the magnetic field generation unit includes a reference point magnet which is fixed to the unmovable layer and used as a reference point at the time of measurement of the differential settlement amount.

5. The land settlement measuring system according to claim 4, wherein the magnetic field generation unit further includes a spider magnet which is disposed at a predetermined position of the settling layer to measure the differential settlement amount.

6. The land settlement measuring system according claim 4, wherein the magnetic field generation unit further includes a plate magnet which is disposed at a predetermined position of the surface of the settling layer and at a predetermined position of the filling layer to measure the differential settlement amount.

7. The land settlement measuring system according to claim 3, wherein the land settlement measuring apparatus includes:
a magnetic field detection unit that includes a plurality of magnetic field detection sensors that are separated from each other in a predetermined interval;
a microprocessor that calculates a differential settlement amount based on a magnetic field detection signal transmitted from the magnetic field detection unit, in the case where a change in the magnetic field is detected by the sensor; and
a containing unit that contains the magnetic field detection unit and the microprocessor.

8. The land settlement measuring system according to claim 7, wherein the land settlement measuring apparatus further includes an interval maintaining rod that supports the containing unit at a predetermined interval.

9. The land settlement measuring system according to claim 5, wherein the magnetic field generation unit further includes a plate magnet which is disposed at a predetermined position of the surface of the settling layer and at a predetermined position of the filling layer to measure the differential settlement amount.
